(19) United States
(12) Patent Application Publication
(10) Pub. No.: US 2018/0153324 A1
(43) Pub. Date: Jun. 7, 2018

(54) TABLEWARE

(71) Applicant: Infinitying Co., Ltd., Tokyo (JP)

(72) Inventor: Katsuyuki ITO, Tokyo (JP)

(73) Assignee: Infinitying Co., Ltd.

(21) Appl. No.: 15/869,081

(22) Filed: Jan. 12, 2018

Related U.S. Application Data
(63) Continuation of application No. PCT/JP2016/087694, filed on Dec. 17, 2016.

(30) Foreign Application Priority Data
Jan. 17, 2016 (JP) 2016-006716

(51) Int. Cl. A47G 21/02; B26B 3/02; A47G 21/10; A47J 43/28

(52) U.S. Cl. CPC A47G 21/02; A47J 43/283; A47G 21/10; B26B 3/02

(57) ABSTRACT

A tableware includes: a first member having a first tableware body on the distal end; and a second member having a second tableware body on the distal end, the second member being connected to the first member at a pivot point so as to be rotatable relatively to each other, the second member being integrated with the first member to constitute tongs using a third-class lever; and a member having a third tableware body on the distal end, the knife being retractably connected to the set of the members at the pivot point so that the third tableware body is positioned between the pair of tableware bodies, the knife being integrated with the pair of members to constitute a fork when gaps are provided between the tableware bodies, the knife being integrated with the pair of members to constitute a spoon when the gaps are not provided between the tableware bodies.

### CROSS-REFERENCES TO RELATED APPLICATIONS

This Application claims the benefit of priority and is a Continuation application of the prior International Patent Application No. PCT/JP2016/087694, with an international filing date of Dec. 17, 2016, which designated the United States, and is related to the Japanese Patent Application No. 2016-006716, filed Jan. 17, 2016, the entire disclosures of all applications are expressly incorporated by reference in their entirety herein.

### BACKGROUND OF THE INVENTION

### 1. Field of the Invention

The present invention relates to a tableware having function of both spoon and fork.

### 2. Description of Related Art

A forked spoon is a spoon having tines at the tip to serve also as a fork. The forked spoon is known as a so-called spoke. (e.g., shown in Japanese Design Registration No. 1486926). The forked spoon is multifunctional tableware, and it is useful in outdoor activities such as camping, hiking, mountain climbing, and the like.

In addition, there are several kinds of multifunctional tableware as follows.

First, there is a tableware in which the handle of a spoon and the handle of a fork are detachably connected. Thus, the tableware has function of spoon, fork and tongs (e.g., shown in Japanese Utility Model Registration No. 3001511, Japanese Utility Model Registration No. 3152055, Japanese Utility Model Registration No. 3195237, Japanese Unexamined Patent Application Publication No. H07-275104, Japanese Unexamined Patent Application Publication No. 2000-342421, and Japanese Unexamined Patent Application Publication No. 2003-144292).

Second, there is a tableware in which the head of a spoon with two handles can be separated corresponding to each two handles. Thus, the tableware has function of spoon and chopsticks (e.g., shown in Japanese Unexamined Patent Application Publication No. 2007-301312).

Third, there is a tableware in which the head of a fork with two handles can be separated corresponding to each two handles. Thus, the tableware has function of fork and chopsticks (e.g., shown in Japanese Unexamined Patent Application Publication No. 2011-519675).

Fourth, there is a tableware in which the head of a spoon with two handles can be separated corresponding to each two handles and the two handles are connected with a hinge and the like. Thus, the tableware has function of spoon and tongs (e.g., shown in Japanese Utility Model Registration No. 3089366 and Japanese Unexamined Patent Application Publication No. 2003-052512).

Fifth, there is a tableware in which the head of a fork with two handles can be separated corresponding to each two handles and the two handles are connected with a hinge and the like. Thus, the tableware has function of fork and tongs (e.g., shown in Japanese Unexamined Patent Application Publication No. 2003-052512).

Sixth, there is a tableware in which the head portion of a forked spoon with two handles can be separated corresponding to each two handles and the two handles are connected with a hinge and the like. Thus, the tableware has function of spoon, fork and tongs (e.g., shown in Japanese Unexamined Patent Application Publication No. 2003-052512).

Seventh, there is a tableware in which a scooping portion of a spoon is provided at one end of the handle and the fork tines are provided at the other end of the handle. Thus, the tableware has function of spoon and fork.

### BRIEF SUMMARY OF THE INVENTION

Although the forked spoon (spoon and fork) serves as a fork as well, the function of fork is so simplified that the usability as a fork is deteriorated.

The tableware (spoon, fork and tongs) described in Japanese Utility Model Registration No. 3001511, Japanese Utility Model Registration No. 3152055, Japanese Utility Model Registration No. 3195237, Japanese Unexamined Patent Publication No. H07-275104, Japanese Unexamined Patent Application Publication No. 2000-342421, and Japanese Unexamined Patent Application Publication No. 2003-144292 is bulky because a spoon used as a single body and a fork used as a single body are combined. Thus, when the tableware is assumed to be carried in the outdoors, the usability is deteriorated.

The tableware (spoon and chopsticks) described in Japanese Unexamined Patent Application Publication No. 2007-301312 cannot be used as chopsticks for people who do not have a custom to use chopsticks, and when used as a spoon, the usability is deteriorated due to the two handles. Furthermore, the tableware cannot serve as a fork.

The tableware (fork and chopsticks) described in Japanese Unexamined Patent Application Publication No. 2011-519675 cannot be used as chopsticks for people who do not have a custom to use chopsticks, and when used as a fork, the usability is deteriorated due to the two handles. Furthermore, the tableware cannot serve as a spoon.

The tableware (spoon and tongs) described in Japanese Utility Model Registration No. 3089366 and Japanese Unexamined Patent Application Publication No. 2003-052512 cannot be used as a fork.

The tableware (fork and tongs) described in Japanese Unexamined Patent Application Publication No. 2003-052512 cannot serve as a spoon.

In the tableware (spoon, fork and tongs) described in Japanese Unexamined Patent Application Publication No. 2003-052512, the function of fork is so simplified that the usability as a fork is deteriorated as in the case of the spork.

The tableware in which a scooping portion of a spoon is provided at one end of the handle and the fork tines are provided at the other end of the handle (spoon and fork) has poor usability because when the tableware is used as either one of spoon or fork and then continuously used as the other, the portion dirty with food has to be grasped as a base end side and the hand will get dirty.

The present invention has been made in view of the above problems, and an object of the present invention is to provide a tableware having function of both spoon and fork and having improved usability.

A tableware according to the present invention includes: a first member having a first tableware body on the distal end of a first handle; and a second member having a second tableware body on the distal end of a second handle, the second member being connected to the first member at a pivot point so as to be rotatable relatively to each other, the second member comprising tongs integrated with the first member using a third-class lever in which the pivot point, an effort point to be a holding portion and a load point to grasp food are provided in an order from the base end to the distal end; and a third member having a third tableware body on the distal end of a third handle, the third member being retractably connected to the first member and the second member at the pivot point so that the third tableware body is positioned between the first tableware body and the second tableware body, the third member being integrated with the first member and the second member to constitute a fork when gaps are provided between the first tableware body and the second tableware body and between the second tableware body and third tableware body, the third member being integrated with the first member and the second member to constitute a spoon when the gaps are not provided between the first tableware body and the second tableware body and between the second tableware body and the third tableware body.

The tableware according to the present invention has function of not only spoon and fork, but also function of tongs. Thus, the usability can be improved. In addition, the tableware is not bulky because it can selectively exert each function of spoon, fork, and tongs as a single body by changing the form. Thus, the tableware has good usability even when the tableware is assumed to be carried in the outdoors. Furthermore, unlike the tableware in which a scooping portion of a spoon is provided at one end of the handle and fork tines are provided at the other end of the handle, in the tableware of the present invention, users do not need to grasp the portion dirty with food to as the base end side. Thus, hands are prevented from getting dirty and the usability is improved.

In the present invention, the above described tableware can be characterized by that the third member constitutes a knife or a skewer when the third member is retracted from the first member and the second member.

The tableware of the above described invention includes function of knife or skewer. Therefore, the usability can be further improved.

The tableware according to the present invention serves as a spoon and a fork and the tableware can improve the usability.

### BRIEF DESCRIPTION OF THE DRAWINGS

FIG. 1 is a top view of a tableware according to the first embodiment of the present invention showing a state in which the tableware serves as a fork.

FIG. 2 is a top view of the tableware shown in FIG. 1 showing a state in which the tableware serves as a spoon.

FIGS. 3A and 3B are top views of components constituting the tableware shown in FIG. 1. FIG. 3A shows tongs and FIG. 3B shows a knife.

FIG. 4 is a side view of the tableware shown in FIG. 1 showing a state in which the knife is retracted.

FIGS. 5A and 5B are top views of components constituting the tableware according to the second embodiment of the present invention. FIG. 5A shows tongs and FIG. 5B shows a skewer.

### DETAILED DESCRIPTION OF THE INVENTION

Hereinafter, a tableware 1 and a tableware 2 according to the embodiments of the present invention will be described in detail with reference to the drawings.

### First Embodiment

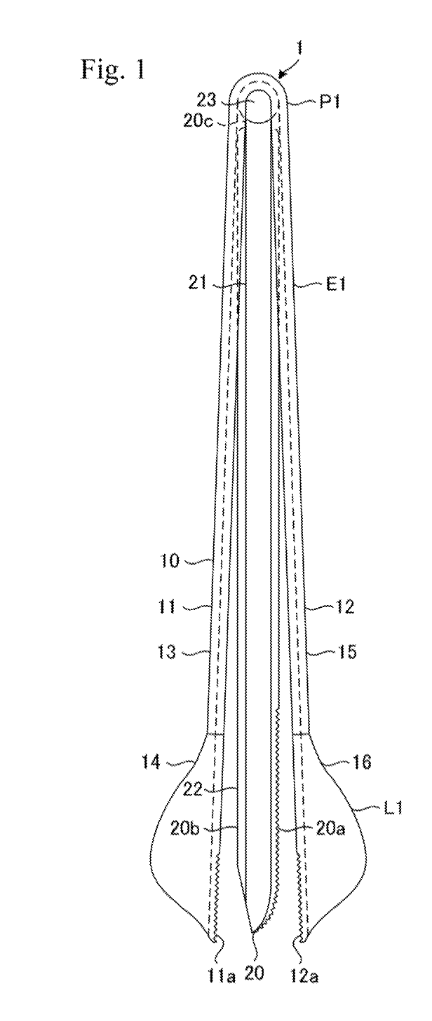

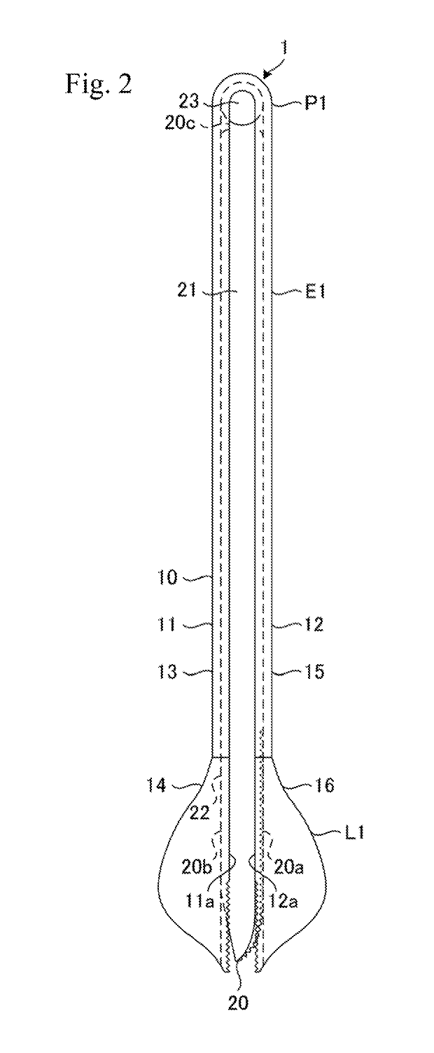

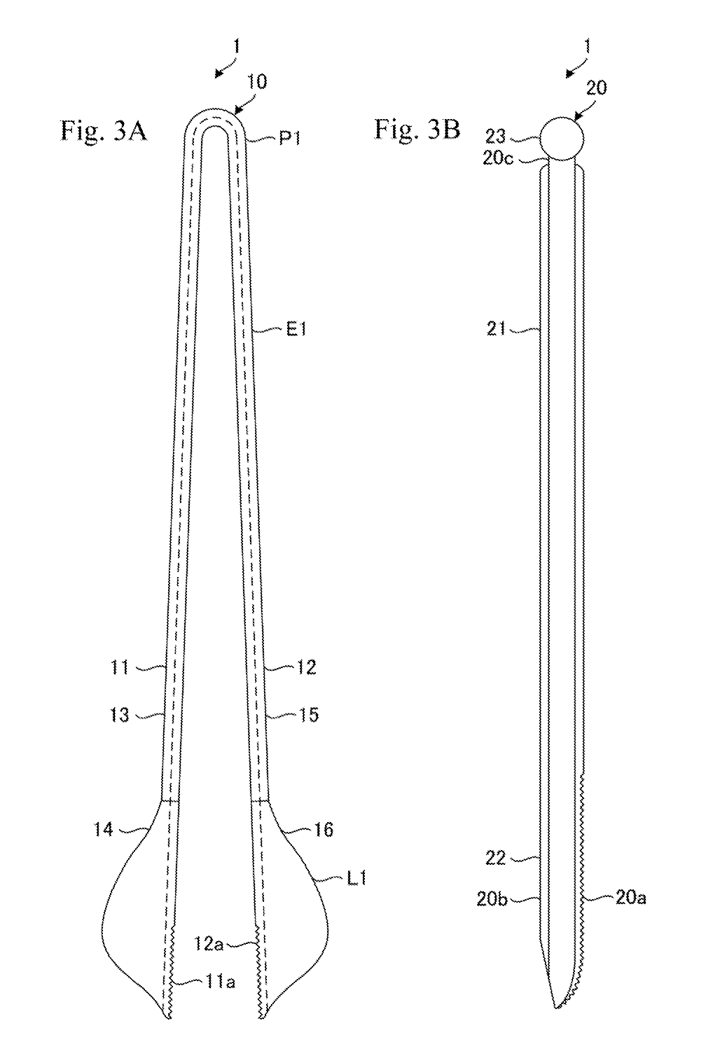

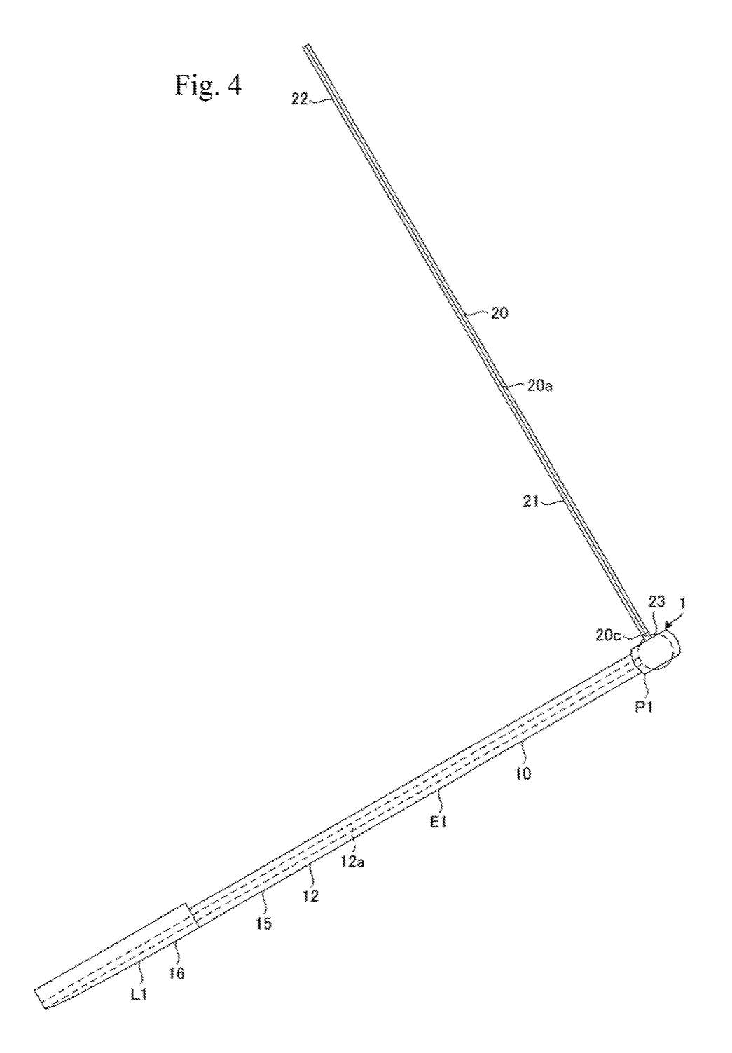

First, the tableware 1 according to the first embodiment will be described with reference to FIGS. 1 to 4. FIG. 1 is a top view of the tableware 1 showing a state in which the tableware serves as a fork. FIG. 2 is a top view of the tableware 1 showing a state in which the tableware serves as a spoon. FIGS. 3A and 3B are top views of components constituting the tableware 1 (tongs 10 and a knife 20). FIG. 3A shows tongs 10. FIG. 3B shows the knife 20. FIG. 4 is a side view of the tableware 1 showing a state in which the knife 20 is retracted. Note that a size, a shape, a thickness and the like of the members shown in each figure are exaggerated appropriately.

The tableware 1 shown in FIGS. 1 to 4 has the function of spoon, fork, knife and tongs, and each function can be switched for use. Specifically, the tableware 1 can be manufactured from various materials such as resin including plastics or metal including iron and stainless steel, and the tableware 1 comprises the tongs 10 and the knife 20. This tableware 1 is as large as typical spoon and fork, and not bulky.

The tongs 10 use a third-class lever in which a pivot point P1, an effort point E1 configured to be a holding portion and a load point L1 configured to grasp food are provided in the order from a base end to a distal end, that is to say, from the upper side to the lower side in FIGS. 1 to 3B. The tongs 10 have a symmetrical shape. Specifically, the tongs 10 comprise a pair of members 11 and 12 connected at the pivot point P1 so as to be rotatable relatively to each other.

A first member 11 which is one of the pair has a first tableware body 14 configured to be the load point L1 at the distal end of a first handle 13 configured to be the effort point E1. In the first member 11, a groove 11a in which a blade line 20a or a back 20b of a knife 20 fits is formed from the base end to the distal end in the portion facing a second member 12 which is the other of the pair. It is preferable that an outer portion of the first handle 13 configured to be the holding portion has a shape not to be slippery for fingers when the outer portion is grasped by hand. It is preferable that an inner portion of the first tableware body 14 configured to grasp food has a serrated edge as a slip-stopper of the grasped food.

As in the case of the first member 11, the second member 12 which is the other of the pair has a second tableware body 16 configured to be the load point L1 at the distal end of a second handle 15 configured to be the effort point E1. In the second member 12, a groove 12a in which the blade line 20a or the back 20b of the knife 20 fits is formed from the base end to the distal end in the portion facing the first member 11 which is the one of the pair. It is preferable that an outer portion of the second handle 15 configured to be the holding portion has a shape not to be slippery for fingers when the outer portion is grasped by hand. It is preferable that an inner portion of the first tableware body 14 configured to grasp food has a serrated edge as a slip-stopper of the grasped food.

In a natural state where no external force is applied to the tongs 10, the pair of members 11 and 12 forms an acute angle so that the pair of members 11 and 12 is separated with each other compared to the parallel position (shown in FIGS. 1 and 3A).

On the other hand, in a state where the external force is applied to the tongs 10, the pair of members 11 and 12 become parallel to each other (shown in FIG. 2) or the pair of members 11 and 12 comes close to each other compared to the parallel position (not shown).

A ball 23 provided at the base end of the knife 20 is rotatably and removably fit into the pivot point P1 of the tongs 10 from predetermined directions (for example, in a direction from a lower side to an upper side in FIGS. 1 to 3B and in a direction from one of the sides of front and back of the paper to the other in FIGS. 1 to 3B). Namely, the knife 20 is retractably connected to the pivot point P1 of the tongs 10 by fitting the ball 23 into the pivot point P1.

As will be described in detail later, the tongs 10 are integrated (used together) with the knife 20 to serve as a fork (shown in FIG. 1) or a spoon (shown in FIG. 2). In addition, the tongs 10 serve as tongs themselves by retracting the knife 20 (shown in FIGS. 3A and 4). For example, the tongs 10 serve as tongs themselves when the knife 20 is removed (shown in FIG. 3A). Alternatively, the tongs 10 serve as tongs themselves when the knife 20 is rotated from between the pair of members 11 and 12 (shown in FIG. 4).

The knife (third member) 20 is retractably connected to the pair of members 11 and 12 constituting the tongs 10 at the pivot point P1 so that the knife (third member) 20 can be retracted with respect to the pair of members 11 and 12. Specifically, the knife 20 has a third tableware body 22 for cutting food at the distal end of a third handle 21, and has the ball 23 for connecting the knife to the pair of members 11 and 12 at the base end of the third handle 21. It is preferable that a part of the blade line 20a of the third tableware body 22 for cutting food has a serrated edge to cut well. The ball 23 is removably fitted to the pivot point P1 so as to be rotatable. As a result, the knife 20 can rotate around the pivot point P1 upward and downward (front side and back side of the paper in FIGS. 1 to 3B) by a predetermined angle (e.g., 90 degrees, 120 degrees).

The blade line 20a and the back 20b of the knife 20 respectively fit into the groove 11a and the groove 12a of the tongs 10. The knife 20 has a constricted and narrowed neck portion 20c between the ball 23 and the blade line 20a and between the ball 23 and the back 20b. When the knife 20 is rotated upward or downward, the neck portion 20c fits into the edge of the groove 11a or 12a of the tongs 10 and locks the rotation of the knife 20 (shown in FIG. 4).

The knife 20 serves as a fork or a spoon when integrated with the tongs 10 and serves as a knife itself when retracted from the tongs 10.

Specifically, when the knife 20 is connected to the pair of members 11 and 12 constituting the tongs 10, the third tableware body 22 is positioned between the pair of tableware bodies 14 and 16. When gaps are provided mutually between the tableware bodies 14, 16 and 22 (between 14 and 22 and between 16 and 22), the knife 20 is integrated with the tongs 10 to serve as a fork (shown in FIG. 1). In this case, each tableware bodies 14, 16, and 22 are integrated and serve as teeth of the fork.

Also, when the knife 20 is connected to the pair of members 11 and 12 constituting the tongs 10, the third tableware body 22 is positioned between the pair of tableware bodies 14 and 16. When the gaps are not provided mutually between the tableware bodies 14, 16 and 22 (between 14 and 22 and between 16 and 22), the blade line 20a and the back 20b of the knife 20 respectively fit into the groove 11a and the groove 12a of the tongs 10. Thus, the knife 20 is integrated with the tongs 10 in which the pair of members do not relatively rotate to serve as a spoon (shown in FIG. 2). In this case, the tableware bodies 14, 16, and 22 are integrated and serve as a head of the spoon. Note that the head of the spoon has a bowl shape or a dish shape. For example, the head of the spoon has a substantially flat plate shape at the center, and its outer peripheral portion is bent obliquely to form an edge. Thus, the head of the spoon forms a bowl shape or a dish shape.

Further, when the knife 20 is removed from the tongs 10, the knife 20 serves as a knife itself (shown in FIG. 3B). Alternatively, the knife 20 serves as a knife itself when it is rotated from between the pair of members 11 and 12 constituting the tongs 10 (shown in FIG. 4).

According to the tableware 1 described above, the tableware 1 serves not only as a spoon and a fork, but also as a knife and tongs. Thus, the usability can be improved. In addition, the tableware 1 is not bulky because it can selectively exert the functions of spoon, fork, knife and tongs as a single body by changing its form. Thus, the tableware 1 has good usability even when the tableware 1 is assumed to be carried in the outdoors. Furthermore, unlike the tableware in which a scooping portion of a spoon is provided at one end of the handle and fork teeth are provided at the other end of the handle, the tableware 1 does not have to be grasped at the portion dirty with food as the base end side. Thus, the tableware 1 prevents hands are prevented from getting dirty and the usability is improved.

### Second Embodiment

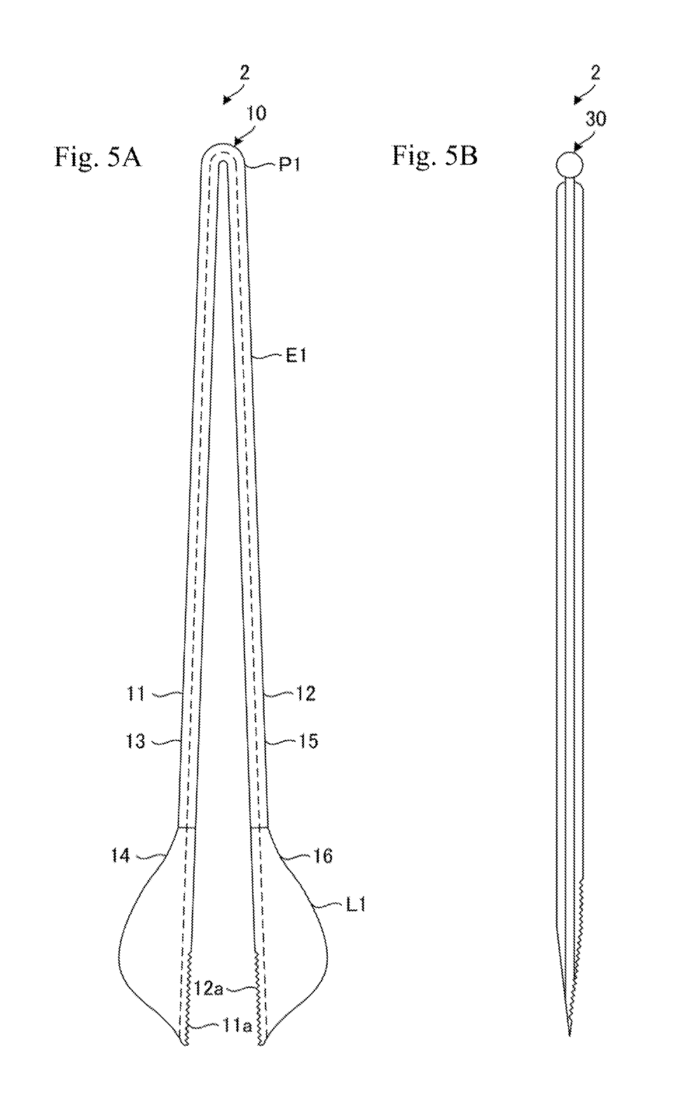

Next, with reference to FIGS. 5A and 5B, a tableware 2 according to the second embodiment will be described. FIGS. 5A and 5B are top views of components (tongs 10, a skewer 30) constituting the tableware 2. Here, it is to be noted that only characterizing portions of the tableware 2 according to the second embodiment will be described, and the description of the configuration and operation similar to the tableware 1 of the first embodiment will be omitted appropriately.

The tableware 2 shown in FIGS. 5A and 5B has the function of spoon, fork, skewer, and tongs, and each function can be switched for use. Specifically, the tableware 2 is obtained by replacing the knife 20 in the tableware 1 with a skewer 30, and the basic structure is the same as the structure of the tableware 1.

It is preferable that the skewer 30 has a serrated edge in a predetermined range from the distal end to promote trapping the food.

According to the tableware 2, it serves not only as a spoon and a fork, but also serves as a skewer and tongs. Thus, the usability can be improved. In addition, the tableware 2 is not bulky because it can selectively exert the function of spoon, fork, skewer and tongs as a single body by changing the form. Thus, the tableware 2 has good usability even when the tableware 2 is assumed to be carried in the outdoors.

The present invention is not limited to the above embodiments, and various modifications are possible without departing from the gist and technical idea of the present invention. Namely, the position, the size, the length, the width, the quantity, the shape, the material and the like of each component can be appropriately changed.

Alternatively, the present invention may be a set of tableware including the tongs 10, the knife 20 and the skewer 30, and either one of the knife 20 or the skewer 30 may be appropriately attached to the tongs 10 to be used.

Alternatively, in the above-described embodiments, the tableware 1 and the tableware 2 may be configured to be foldable. Namely, the tableware 1 may have a configuration in which the tongs 10 and the knife 20 can be integrally folded in half, and the tableware 2 may have a configuration in which the tongs 10 and the skewer 30 can be integrally folded in half.

Each of the above-described embodiments focuses on the function of the knife 20 or the skewer 30 by forming the knife 20 or the skewer 30 to be a straight and flat shape without being curved and by forming the tongs 10 to be also a straight shape to fit the shape of the knife 20 or the skewer 30. However, the present invention is not limited to this. Alternatively, the present invention may be configured to focus on the function of the spoon by forming the knife 20 or the skewer 30 to be curved and by forming the tongs 10 to be curved to fit the shape of the knife 20 or the skewer 30.

Alternatively, in each of the above-described embodiments, the size of the first tableware body 14 or the second tableware body 16 may be configured to be large for use as a head of the spoon. With this configuration, the present invention can serve as a spoon while serving as a fork.

### DESCRIPTION OF THE REFERENCE NUMERALS

1, 2 tableware
10 tongs
11 first member
11a groove
12 second member
12a groove
13 first handle
14 first tableware body
15 second handle
16 second tableware body
20 knife (a third member)
20a blade line
20b back
20c neck portion
21 third handle
22 third tableware body
23 ball
30 skewer
P1 pivot point (fulcrum)
E1 point of effort
L1 point of load

What is claimed is:

1. A tableware, comprising:
a first member having a first tableware body on the distal end of a first handle; and
a second member having a second tableware body on the distal end of a second handle, the second member being connected to the first member at a pivot point so as to be rotatable relatively to each other, the second member being integrated with the first member to constitute tongs using a third-class lever in which the pivot point, an effort point configured to be a holding portion and a load point configured to grasp food are provided in an order from the base end to the distal end; and
a third member having a third tableware body on the distal end of a third handle, the third member being retractably connected to the first member and the second member at the pivot point so that the third tableware body is positioned between the first tableware body and the second tableware body, the third member being integrated with the first member and the second member to constitute a fork when gaps are provided between the first tableware body and the second tableware body and between the second tableware body and third tableware body, the third member being integrated with the first member and the second member to constitute a spoon when the gaps are not provided between the first tableware body and the second tableware body and between the second tableware body and the third tableware body.

2. The tableware according to claim 1, wherein
the third member constitutes a knife or a skewer when the third member is retracted from the first member and the second member.
